(19) United States
(12) Patent Application Publication
(10) Pub. No.: US 2013/0330552 A1
(43) Pub. Date: Dec. 12, 2013

(54) INSULATED WIRE AND COIL USING SAME

(71) Applicant: HITACHI CABLE, LTD., Tokyo (JP)

(72) Inventors: Yuki HONDA, Hitachi (JP); Takami USHIWATA, Hitachi (JP); Shuta NABESHIMA, Hitachi (JP); Hideyuki KIKUCHI, Hitachi (JP)

(21) Appl. No.: 13/911,287

(22) Filed: Jun. 6, 2013

(30) Foreign Application Priority Data
Jun. 12, 2012 (JP) 2012-132767

(51) Int. Cl. H01B 7/29

(52) U.S. Cl. CPC H01B 7/292
USPC 428/379

(57) ABSTRACT

An insulated wire includes a conductor, and an insulating coating provided around the conductor, and including a polyamide imide layer comprising a polyamide imide consisting essentially of a structural unit represented by Formula (1) below, and Ar in Formula (1) mainly containing an aromatic group represented by Formula (2) below.

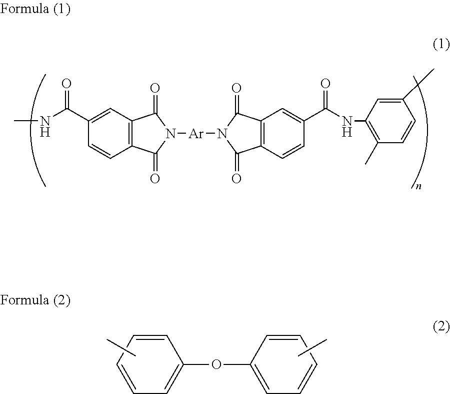

The present application is based on Japanese patent application No. 2012-132767 filed on Jun. 12, 2012, the entire contents of which are incorporated herein by reference.

### BACKGROUND OF THE INVENTION

1. Field of the Invention

The present invention relates to an insulated wire comprising a polyamide imide layer made of a polyamide imide not containing aliphatic series and a coil using the same insulated wire.

2. Description of the Related Art

In recent years, with higher performance and miniaturization of electric equipment, winding wires for motors (hereinafter referred to as “motor windings”) in various applications have been developed.

For example, because in an inverter motor its continuous use at high temperatures is assumed depending on its operating environment, the motor windings to be provided for the inverter motor are required to have high heat resistance.

Therefore, an enameled wire (hereinafter referred to as “insulated wire”) having an insulating layer made of polyimide is marketed as a motor winding to withstand continuous use at high temperatures. This insulated wire maintains a high flexibility and dielectric breakdown characteristic even after long-term high temperature thermal degradation, and therefore are widely used in applications for the motor windings.

Meanwhile, the coil molding process requires insertion in a slot of a coil (hereinafter referred to as “coil insertion”) formed for the motor winding, and due to this coil insertion, an abrasion may occur in the surface of the insulating layer (hereinafter, referred to as “coated surface”). Therefore, it is required to suppress such an abrasion.

As the motor winding being excellent in wear resistance, likely to cause no abrasion in the coated surface due to coil insertion during coil molding process, and having sufficient workability, there is an insulated wire comprising an insulating layer made of a polyamide imide, which is synthesized from dicyclohexylmethane 4,4′-diisocyanate and trimellitic acid anhydride.

As the polyamide imide forming the insulating layer, there is known one (refer to e.g., JP-B 4473916) which contains an aromatic diisocyanate component having three or more benzene rings as monomers, and in which the ratio of a molecular weight per repeating unit and the average number of imide groups and amide groups is 200 or more. By forming the insulating layer of this polyamide imide, it is possible to lower the dielectric constant of the insulating layer and improve the partial discharge inception voltage.

In addition, there is a polyamide imide (refer to e.g., JP-A 3-181511) which is produced by two-stage reaction of a reaction between aromatic tricarboxylic acid anhydride and 2,2-bis[4-(4-aminophenoxy) phenyl] propane (BAPP) or bis[4-(4-aminophenoxy) phenyl] sulfone (BAPS) so that the ratio thereof is in an acid component excess range of 100:50 to 100:80, and a subsequent reaction of diisocyanate. By forming the insulating layer of this polyamide imide, it is possible to improve the mechanical properties and heat resistance of the insulating layer.

Also, there is a polyamide imide (refer to e.g., JP-A 2004-211055) which is produced by, when reacting a diisocyanate with an imide group-containing dicarboxylic acid which is produced by a reaction between trimellitic anhydride and a diamine compound, containing an aromatic diamine having two aromatic rings as the diamine compound, in which the two aromatic rings are bonded so as to inhibit the rotation of one aromatic ring relative to the other aromatic ring. By forming the insulating layer of this polyamide imide, it is possible to improve the heat resistance of the insulating layer.

Furthermore, there is a polyamide imide (refer to e.g., JP-A 2005-146118) which is produced by, after producing a polymer by a reaction between a first diisocyanate compound and a first dicarboxylic acid which is any type of a group consisting of aromatic dicarboxylic acids and non-aromatic dicarboxylic acids, reacting a second dicarboxylic acid of a type different from the first dicarboxylic acid of the above group, a second diisocyanate compound, and a polymer thereof. By forming the insulating layer of this polyamide imide, it is possible to improve the heat resistance of the insulating layer.

Refer to JP-B 4473916, JP-A 3-181511, JP-A 2004-211055, and JP-A 2005-146118, for example.

### SUMMARY OF THE INVENTION

Because the insulated wire comprising the insulating layer made of polyimide is poor in wear resistance, an abrasion tends to occur in the coated surface due to coil insertion during coil molding process, and the insulated wire has no sufficient workability.

Meanwhile, there is a disadvantage that the insulated wire comprising the insulating layer made of polyimide which is synthesized from dicyclohexylmethane 4,4′-diisocyanate and trimellitic acid anhydride is difficult to withstand continuous use at high temperatures due to an aliphatic contained in the polyamide imide which constitutes the insulating layer.

Accordingly, an object of the present invention is to provide an insulated wire capable of withstanding continuous use at high temperatures, and suppressing an abrasion in coated surface due to coil insertion during coil molding process, and a coil using the same insulated wire.

(1) According to one embodiment of the invention, an insulated wire comprises:

a conductor; and

an insulating coating provided around the conductor, and including a polyamide imide layer composed of a polyamide imide consisting essentially of a structural unit represented by Formula (1) below, and Ar in Formula (1) mainly containing an aromatic group represented by Formula (2) below.

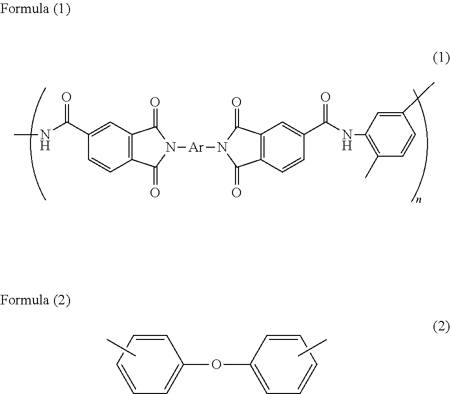

In one embodiment, the following modifications and changes can be made.

(i) The polyamide imide layer preferably comprises a polyamide imide containing an aromatic group represented by the Formula (2) in a proportion greater than 70 mol % as the Ar.

(ii) The polyamide imide layer further contains at least one of an aromatic group represented by Formula (3) below and an aromatic group represented by Formula (4) below as the Ar.

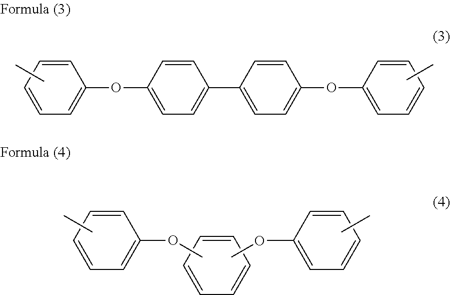

(iii) The insulating coating includes a first insulating layer provided on an outer periphery of the conductor, and a second insulating layer comprising a polyamide imide layer provided on an outer periphery of the insulating layer.

(iv) The above insulated wire further comprises an adhesion improving agent added in the first insulating layer.

(2) According to another embodiment of the invention, a coil comprising the above specified insulated wire.

### POINTS OF THE INVENTION

According to the present invention, it is possible to provide the insulated wire capable of withstanding continuous use at high temperatures, and suppressing an abrasion in the coated surface due to coil insertion during coil molding process, and the coil using the same insulated wire.

### BRIEF DESCRIPTION OF THE DRAWINGS

The preferred embodiments according to the invention will be explained below referring to the drawings, wherein:

FIG. 1 is a sectional view showing an insulated wire in a first embodiment according to the present invention;

FIG. 2 is a sectional view showing an insulated wire in a second embodiment according to the present invention; and

FIG. 3 is a sectional view showing an insulated wire in a third embodiment according to the present invention.

### DETAILED DESCRIPTION OF THE PREFERRED EMBODIMENTS

Below are described preferred embodiments according to the invention, in conjunction with the accompanying drawings.

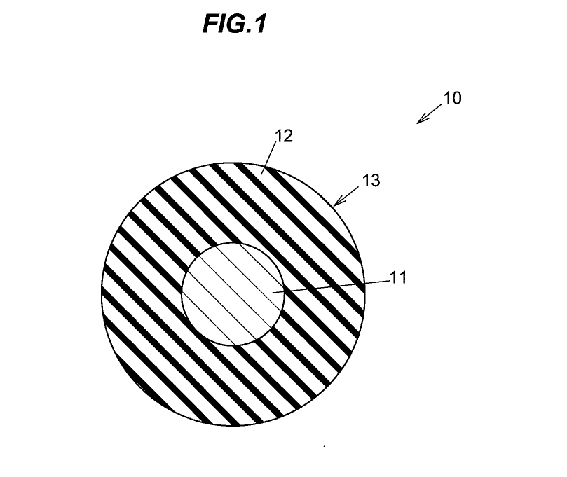

As shown in FIG. 1, an insulated wire 10 in a first embodiment comprises a conductor 11, and an insulating coating 13 provided around the conductor 11, and including a polyamide imide layer 12 comprising a polyamide imide consisting essentially of a structural unit represented by Formula (1) below, and Ar in Formula (1) mainly containing an aromatic group represented by Formula (2) below.

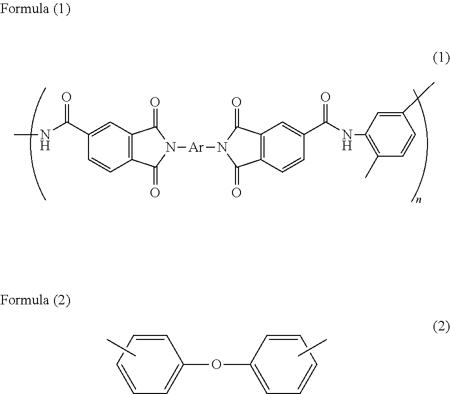

It is preferable that the polyamide imide layer 12 comprises a polyamide imide containing an aromatic group represented by Formula (2) in a proportion greater than 70 mol % as Ar.

Further, it is preferable that the polyamide imide layer 12 further contains at least one of an aromatic group represented by Formula (3) and an aromatic group represented by Formula (4) as Ar.

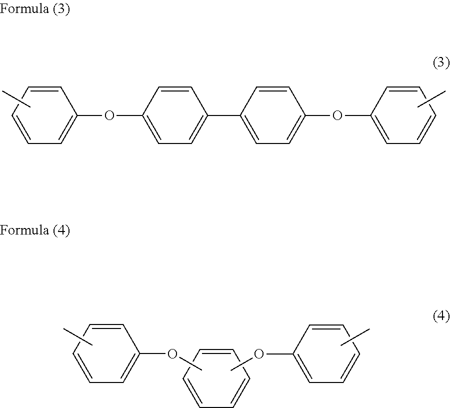

The polyamide imide consisting essentially of the structural unit represented by Formula (1), and Ar in Formula (1) being the aromatic group represented by Formula (2), or using a combination of this and the aromatic group of Formula (3), Formula (4) is synthesized by reacting trimellitic anhydride and divalent aromatic diamine not containing aliphatic to synthesize a carboxylic acid terminated imide compound, thereafter reacting tolylene 2,4-diisocyanate.

As the divalent aromatic diamine containing no aliphatic, there can particularly preferably be listed diamines such as 4,4′-diaminodiphenyl ether (ODA), 3,4′-diaminodiphenyl ether, 3,3′-diaminodiphenyl ether, 1,4-bis(4-aminophenoxy) benzene (TPE-Q), 1,3-bis(4-aminophenoxy) benzene (TPE-R), 1,3-bis(3-aminophenoxy) benzene (APB), 4,4′-bis(4-aminophenoxy) biphenyl (BAPB), 4,4′-bis(3-aminophenoxy) biphenyl (m-BAPB), and the like.

It is possible to form a coil by winding around an iron core the insulated wire 10 described heretofore.

Thus the insulated wire 10 includes the polyamide imide layer 12 comprising the polyamide imide consisting essentially of the structural unit represented by Formula (1) and Ar in Formula (1) being the aromatic group represented by Formula (2).

Since the polyamide imide synthesized from Formula (2) contains no aliphatic, it is possible to withstand continuous use at high temperatures. Because of inherent wear resistance of the polyamide imide, it is possible to suppress the occurrence of an abrasion in the coated surface due to coil insertion during coil molding process.

Further, by Formula (2) being contained in Ar in Formula (1) in a range of more than 70 mol % and not more than 100 mol %, it is possible to maintain the glass transition temperature at a high level (high temperature), therefore it is possible to be not likely to cause a decrease in dimensional stability at high temperatures and softening temperature, and it is also possible to be not likely to cause a decrease in the flexibility after long-term thermal degradation and in the dielectric breakdown voltage after long-term thermal degradation.

Furthermore, when using Formula (3), Formula (4) in conjunction with Formula (2), because the concentration of the imide group in the molecular structure of the polyamide imide resin lowers to reduce the polarity, the water absorption rate decreases and it is possible to suppress the occurrence of dielectric breakdown due to water absorption.

Thus, the insulated wire 10 comprising the polyamide imide layer 12 made of such a polyamide imide can withstand continuous use at high temperatures, and suppress an abrasion in the coated surface due to coil insertion during coil molding process. The term “high temperatures” herein is temperatures on the order of “220 degrees Celsius to 240 degrees Celsius,” and means that the continuous use at least for 1000 hours is performed in an atmosphere at the high temperatures.

In the present invention, by providing both the “ability to withstand continuous use at high temperatures,” and the “ability to suppress an abrasion in one coated surface due to coil insertion during coil molding process,” it is possible to suppress dielectric breakdown voltage lowering due to an abrasion during coil molding process, and by suppressing the reduction of the dielectric breakdown voltage due to degradation (e.g., film cracking) at high temperatures assuming practical use, it is possible to provide a highly reliable motor which is not likely to lower in the dielectric breakdown voltage in processing and practical use.

In addition, a typical polyamide imide layer uses a polyamide imide comprising 4,4′-diphenylmethane diisocyanate (4,4′-MDI) for an isocyanate component, and therefore after long-term thermal degradation, tends to deteriorate by oxidation resulting from containing an aliphatic, and its elongation lowers and its flexibility worsens. On contrast, the polyamide imide layer of the present invention is not likely to lower in elongation especially even after long-term thermal degradation, and is therefore suitable for in particular a motor, etc. requiring higher heat resistance (long-term thermal deterioration resistance) than the conventional polyamide imide layer.

Then, a second embodiment will be explained.

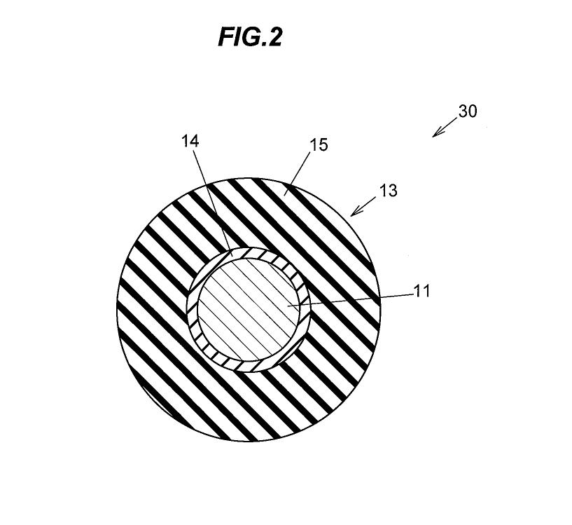

As shown in FIG. 2, the insulated wire 20 in the second embodiment is different compared to the insulated wire 10 in that the insulating coating 13 includes a first insulating layer 14 formed on an outer periphery of the conductor 11, and a second insulating layer 15 comprising a polyamide imide layer 12 formed on an outer periphery of the insulating layer 14.

It is preferred that an adhesion improving agent is added in the first insulating layer 14. For example, by the first insulating layer 14 being made of any of polyimide, polyamide imide, polyester imide or epoxy added with the adhesion improving agent for improving the adhesion to the conductor 11, the insulating coating 13 and the conductor 11 are less likely to peel off and it is possible to suppress the occurrence of partial discharge due to this.

In particular, when the first insulating layer 14 comprises polyamide imide, it may be constituted by adding an adhesion enhancing agent in the same polyamide imide as the polyamide imide constituting the second insulating layer 15. This is because if the chemical structure (molecular structure) of the resin constituting each layer of the first insulating layer 14 and the second insulating layer 15 is significantly different, there is a possibility that the delamination occurs in the evaluation of adhesion of the insulating layer, but because the chemical structures of the resins constituting each layer of the first insulating layer 14 and the second insulating layer 15 are similar, it is possible to prevent the occurrence of delamination. It is also because the water absorption rate of the first insulating layer 14 is low, therefore it is possible to suppress a decrease in adhesion to the conductor 11 due to water absorption of the first insulating layer 14.

Of course, as with the insulated wire 10 in the first embodiment, with the insulated wire 20, it is possible to withstand continuous use at high temperatures, and suppress the abrasion of the coated surface due to coil insertion during coil molding process.

Then, a third embodiment will be explained.

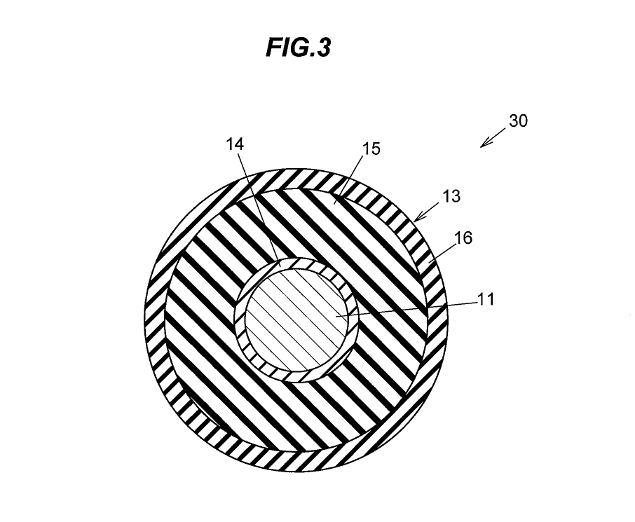

As shown in FIG. 3, an insulated wire 30 in the third embodiment is one further provided with a lubricating layer 16 on an outer periphery of the insulated wire 20 in the second embodiment.

The lubricating layer 16 is constituted by adding a lubricant to a resin such as polyimide, polyamide imide, polyester imide, etc.

Further, the lubricating layer 16 may be one which is configured by applying a lubricant mainly comprising carnauba wax and the like on the coating of the second insulating layer 15.

Thus, according to the insulated wire 30 in the embodiment of the third, and that it further comprises a lubricating layer 16 formed on the outer periphery of the insulating layer 15 of the second, friction due to coil insertion of the coil molding process is reduced, it is possible to suppress the occurrence of the coated surface abrasion.

Of course, as with the insulated wire 10 in the first and second embodiments, with the insulated wire 30, it is possible to withstand continuous use at high temperatures, which can suppress the abrasion of the coated surface with coil insertion of the coil during molding process. Although in the first to the third embodiments, as the preparation method of the polyamide imide coating for forming the polyamide imide layer 12, the synthetic method of decarboxylation at high temperatures of a diisocyanate compound and trimellitic anhydride is generally used, it is not limited thereto, but may use, e.g., a synthesis method by causing a dehydration reaction between diamine and trimellitic anhydride, a synthesis method by causing a reaction between diamine and acid dianhydride having an amide bond, a synthesis method by causing a reaction between diamine and an acid chloridized compound of carboxylic acid of trimellitic anhydride, etc.

### EXAMPLES

Next, examples of the present invention and comparative examples will be explained.

Herein, insulated wires are produced by changing the configuration of the first insulating layer and the second insulating layer, and the wear resistance (reciprocating wear), the flexibility after long-term thermal degradation and the dielectric breakdown voltage after long-term thermal degradation of these insulated wires are investigated.

First, a method of producing the insulated wires in the Examples and the Comparative examples will be explained.

### Example 1

With a reaction apparatus including a stirrer, a reflux condenser, a nitrogen inlet tube, and a thermometer, trimellitic anhydride and 4,4′-diaminodiphenyl ether were blended together so that the mole amount of the trimellitic anhydride was two times the mole amount of the 4,4′-diaminodiphenyl ether, and xylene and N-methyl-2-pyrrolidone were added therein, followed by a reaction at stirring rotation speed 180 rpm, nitrogen flow rate of 1 L/min, and at system temperature 180 degrees Celsius, for 4 hours. Xylene and water created during dehydration reaction was once collected in a receptacle, and appropriately evaporated to outside of the system. After cooling to 90 degrees Celsius, tolylene 2,4-diisocyanate was blended, followed by a reaction at stirring rotation speed 150 rpm, nitrogen flow rate of 0.1 L/min, and at a system temperature of 130 degrees Celsius, for 1 hour. Thereafter, N-methyl-2-pyrrolidone was added, to produce a polyamide imide coating A.

A polyimide coating A made in Example 4 to be described later was applied around a copper conductor and baked to form the first insulating layer having a film thickness of 0.002 mm, and thereafter a further polyamide imide coating A was applied therearound and baked to form the second insulating layer comprising a polyamide imide layer having a film thickness of 0.038 mm. This resulted in an Example 1 insulated wire having an insulating coating of total film thickness 0.040 mm.

### Example 2

With a reaction apparatus including a stirrer, a reflux condenser, a nitrogen inlet tube, and a thermometer, trimellitic anhydride and 1,3-bis(4-aminophenoxy) benzene (TPE-R) and 4,4′-diaminodiphenyl ether (ODA) were blended together so that the molar ratio of 1,3-bis(4-aminophenoxy) benzene (TPE-R) and 4,4′-diaminodiphenyl ether (ODA) was 25/75 mole %, and the mole amount of the trimellitic anhydride was two times the total molar amount of 1,3-bis(4-aminophenoxy) benzene (TPE-R) and 4,4′-diaminodiphenyl ether (ODA), and xylene and N-methyl-2-pyrrolidone were added therein, followed by a reaction at stirring rotation speed 180 rpm, nitrogen flow rate of 1 L/min, and at system temperature 180 degrees Celsius, for 4 hours. Xylene and water created during dehydration reaction was once collected in a receptacle, and appropriately evaporated to outside of the system. After cooling to 90 degrees Celsius, tolylene 2,4-diisocyanate was blended, followed by a reaction at stirring rotation speed 150 rpm, nitrogen flow rate of 0.1 L/min, and at a system temperature of 130 degrees Celsius, for 1 hour. Thereafter, N-methyl-2-pyrrolidone was added, to produce a polyamide imide coating B.

The polyamide imide coating B was applied around a copper conductor and baked, resulting in an Example 2 insulated wire having an insulating coating comprising a polyamide imide layer of film thickness 0.040 mm.

### Example 3

With a reaction apparatus including a stirrer, a reflux condenser, a nitrogen inlet tube, and a thermometer, trimellitic anhydride and 4,4′-bis(4-aminophenoxy) biphenyl (BAPB) and 4,4′-diaminodiphenyl ether (ODA) were blended together so that the molar ratio of 4,4′-bis(4-aminophenoxy) biphenyl (BAPB) and 4,4′-diaminodiphenyl ether (ODA) was 25/75 mole %, and the mole amount of the trimellitic anhydride was two times the total molar amount of 4,4′-bis(4-aminophenoxy) biphenyl (BAPB) and 4,4′-diaminodiphenyl ether (ODA), and xylene and N-methyl-2-pyrrolidone were added therein, followed by a reaction at stirring rotation speed 180 rpm, nitrogen flow rate of 1 L/min, and at system temperature 180 degrees Celsius, for 4 hours. Xylene and water created during dehydration reaction was once collected in a receptacle, and appropriately evaporated to outside of the system. After cooling to 90 degrees Celsius, tolylene 2,4-diisocyanate was blended, followed by a reaction at stirring rotation speed 150 rpm, nitrogen flow rate of 0.1 L/min, and at a system temperature of 130 degrees Celsius, for 1 hour. Thereafter, N-methyl-2-pyrrolidone was added, to produce a polyamide imide coating C.

The polyamide imide coating C was applied around a copper conductor and baked, resulting in an Example 3 insulated wire having an insulating coating comprising a polyamide imide layer of film thickness 0.040 mm.

### Example 4

4,4′-diaminodiphenyl ether was put in a reaction apparatus including a stirrer, a reflux condenser, a nitrogen inlet tube, and a thermometer, and N-methyl-2-pyrrolidone was added therein, and thereafter was dissolved therein at stirring rotation speed 180 rpm and at nitrogen flow rate of 1 L/min, and pyromellitic anhydride was then put therein, followed by a reaction at stirring rotation speed 180 rpm, nitrogen flow rate of 1 L/min, and with system temperature set at room temperature, for 6 hours to produce a polyimide coating A.

The polyimide coating A was applied around a copper conductor and baked to form the first insulating layer having a film thickness of 0.002 mm, and thereafter a further polyamide imide coating A was repeatedly applied therearound and baked to form the second insulating layer comprising a polyamide imide layer having a film thickness of 0.038 mm. This resulted in an Example 4 insulated wire having an insulating coating of total film thickness 0.040 mm.

### Example 5

Except that the mole ratio of ODA and TPE-R of Example 2 was 40/60 mol %, the insulated wire was produced in the same manner as in Example 2.

### Example 6

Except that the mole ratio of ODA and TPE-R of Example 2 was 5/95 mol %, the insulated wire was produced in the same manner as in Example 2.

### Comparative Example 1

With a reaction apparatus including a stirrer, a reflux condenser, a nitrogen inlet tube, and a thermometer, equal mole amounts of trimellitic anhydride and dicyclohexylmethane 4,4′-diisocyanate were blended together, and N-methyl-2-pyrrolidone and N, N-dimethylformamide were added therein, followed by a reaction at stirring rotation speed 180 rpm, nitrogen flow rate of 1 L/min, and at system temperature 120 degrees Celsius, for 1 hour, to produce a polyamide imide coating D.

The polyamide imide coating D was applied around a copper conductor and baked, resulting in a Comparative example 1 insulated wire having an insulating coating of film thickness 0.040 mm.

### Comparative Example 2

The polyimide coating A was applied around a copper conductor and baked, resulting in a Comparative example 2 insulated wire having an insulating coating having a film thickness of 0.040 mm.

### Comparative Example 3

With a reaction apparatus including a stirrer, a reflux condenser, a nitrogen inlet tube, and a thermometer, trimellitic anhydride and 4,4′-diaminodiphenyl ether were blended together so that the mole amount of the trimellitic anhydride was two times the mole amount of the 4,4′-diaminodiphenyl ether, and xylene and N-methyl-2-pyrrolidone were added therein, followed by a reaction at stirring rotation speed 180 rpm, nitrogen flow rate of 1 L/min, and at system temperature 180 degrees Celsius, for 4 hours. Xylene and water created during dehydration reaction was once collected in a receptacle, and appropriately evaporated to outside of the system. After cooling to 90 degrees Celsius, dicyclohexylmethane 4,4′-diisocyanate was blended, followed by a reaction at stirring rotation speed 150 rpm, nitrogen flow rate of 0.1 L/min, and at a system temperature of 130 degrees Celsius, for 1 hour. Thereafter, N-methyl-2-pyrrolidone was added, to produce a polyamide imide coating E.

The polyimide coating A was applied around a copper conductor and baked, resulting in a Comparative example 3 insulated wire having an insulating coating having a film thickness of 0.040 mm.

Then, an investigation method of wear resistance (reciprocating wear), the flexibility after long-term thermal degradation, and dielectric breakdown voltage after long-term thermal degradation will be described.

(Wear Resistance (Reciprocating Wear))

After cutting into 120 mm each insulated wire produced in the examples and Comparative examples, shaving with Avisofix device an insulating layer at one side end, this was fitted to the Wear Tester TS-4 (Toei Industry Co., Ltd.), and electrodes were attached with a crocodile clip to one side end with the insulating layer shaved. Then, a wire was put on the surface of the insulating layer, and with a load of 5.9 N (0.6 kgf) applied to the wire, the reciprocating wear of amplitude 20 mm was performed. The number of reciprocating wears is the reciprocating frequency when performed, the insulating layer is worn by the reciprocating wear, and the wire is contacted and electrically connected with the conductor.

(Flexibility after Long-Term Thermal Degradation)

The insulated wires produced in the Examples and Comparative examples were each put in a constant temperature bath which was set to 260 degrees Celsius. After 1000 hours, 5 coils (1 coil consisting of 5 turns) were wound around a round rod having smooth surface and an outer diameter of 1 to 10 times the conductor diameter of the insulated wire. The outer diameter of the minimum winding rod with no cracking seen in the insulating layer at the time of winding of the insulated wire was represented by a multiple of the conductor diameter d of the insulated wire, and this was used as an index of flexibility.

(Breakdown Voltage after Long-Term Thermal Degradation)

The insulated wires produced in the Examples and Comparative examples was each cut into 500 mm, and a load of 14.7 N (1.5 kgf) was applied to the central portion thereof to produce samples of twisted pairs of insulated wires having 9 twist portions in the range of 120 mm. And insulating layers of these samples of insulated wires were shaved with Avisofix device.

Thereafter the samples of the insulated wires with the insulating layer shaved were each put in the constant temperature bath which was set to 260 degrees Celsius. After 1000 hours, terminated portions of these samples of insulated wires were connected to AC dielectric breakdown voltage test apparatus BDV-20K50K (pulses electronic technology Co. Ltd.). The voltage was boosted from 0V to 20.0 kV in air and the dielectric breakdown voltage was set at a voltage at which the insulating layer was destroyed.

Investigated results thereof are shown together in Table 1.

TABLE 1

| | | | | | | | Comparative | Comparative | Comparative |
|---|---|---|---|---|---|---|---|---|---|
| Item | Example 1 | Example 2 | Example 3 | Example 4 | Example 5 | Example 6 | example 1 | example 2 | example 3 |
| Wear resistance | 242 | 235 | 230 | 214 | 225 | 240 | 260 | 75 | 240 |
| (reciprocating | | | | | | | | | |
| wear) | | | | | | | | | |
| Flexibility | 2 d | 2 d | 2 d | 2 d | 2 d | 2 d | >10 d | 2 d | >10 d |
| after long-term | | | | | | | | | |
| thermal | | | | | | | | | |
| degradation | | | | | | | | | |
| Dielectric | 18.5 | 18.2 | 18.2 | 18 | 18.2 | 18.4 | Unmeasurable | 17.2 | Unmeasurable |
| breakdown | | | | | | | | | |
| voltage (kV) | | | | | | | | | |
| after long-term | | | | | | | | | |
| thermal | | | | | | | | | |
| degradation | | | | | | | | | |

Looking at Table 1, Examples 1 to 4 are excellent in the flexibility and the dielectric breakdown voltage after long-term thermal degradation because after the trimellitic anhydride and the divalent aromatic diamine not containing aliphatic were reacted together to synthesize the carboxylic acid terminated imide compound, the second insulating layer was formed using the polyamide imide coatings A, B, and C which were synthesized by reacting the tolylene 2,4-diisocyanate. It is found that Examples 1 to 4 allow withstanding continuous use at high temperatures. It is found that because of inherent wear resistance of the polyamide imide, Examples 1 to 4 allow suppressing the occurrence of an abrasion in the coated surface due to coil insertion during coil molding process.

In contrast, although Comparative examples 1 and 3 are excellent in the wear resistance because of the second insulating layer formed using the aliphatic containing polyamide imide coatings D and E, they are poor in the flexibility and the dielectric breakdown voltage after long-term thermal degradation due to the poor heat resistance property of the polyamide imide in comparison to Examples 1 to 6.

Incidentally, in Table 1, the term “unmeasurable” in the dielectric breakdown voltage test after long-term thermal degradation in Comparative examples 1 and 3 means that the dielectric breakdown was not able to be tested because the coating film had already been cracked by the long-term thermal degradation test.

Further, although Comparative example 2 is excellent in the flexibility and the dielectric breakdown voltage after long-term thermal degradation because of the insulating coating formed using the polyimide coating A, the abrasion of the coated surface due to coil insertion during coil molding process tends to occur in Comparative example 2 due to the poor wear resistance property of the polyimide in comparison to Examples 1 to 6.

From these results, it is found that the insulated wire according to the present invention is capable of withstanding continuous use at high temperatures and suppressing the occurrence of an abrasion in the coated surface due to coil insertion during coil molding process.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An insulated wire, comprising:
a conductor; and
an insulating coating provided around the conductor, and including a polyamide imide layer comprising a polyamide imide consisting essentially of a structural unit represented by Formula (1) below, and Ar in Formula (1) mainly containing an aromatic group represented by Formula (2) below.

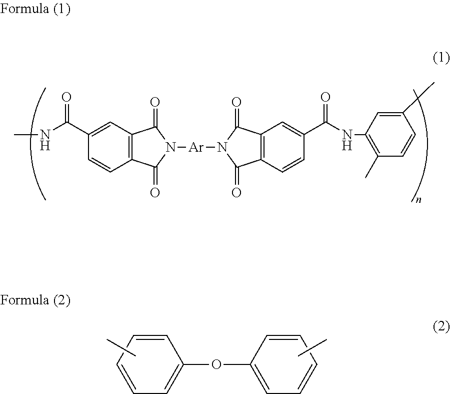

2. The insulated wire according to claim 1, wherein the polyamide imide layer comprises a polyamide imide containing an aromatic group represented by the Formula (2) in a proportion greater than 70 mol % as the Ar.

3. The insulated wire according to claim 1, wherein the polyamide imide layer further contains at least one of an aromatic group represented by Formula (3) below and an aromatic group represented by Formula (4) below as the Ar.

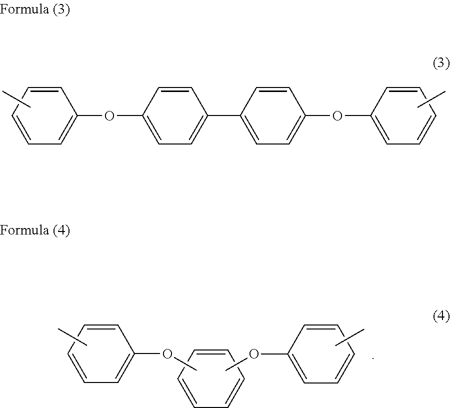

4. The insulated wire according to claim 1, wherein the insulating coating includes a first insulating layer provided on an outer periphery of the conductor, and a second insulating layer comprising a polyamide imide layer provided on an outer periphery of the insulating layer.

5. The insulated wire according to claim 4, further comprising:
an adhesion improving agent added in the first insulating layer.

6. A coil comprising the insulated wire according to claim 1.
